(19) United States
(12) Patent Application Publication
(10) Pub. No.: US 2005/0193065 A1
(43) Pub. Date: Sep. 1, 2005

(54) E-mail processing server

(76) Inventors: Mika Sugimoto, Asaka-shi (JP); Shino Ogasawara, Kawasaki-shi (JP)

Correspondence Address: BIRCH STEWART KOLASCH & BIRCH, PO BOX 747, FALLS CHURCH, VA, 22040-0747, US

(21) Appl. No.: 10/665,501

(22) Filed: Sep. 22, 2003

(30) Foreign Application Priority Data
Sep. 26, 2002 (JP) P. 2002-281423

(51) Int. Cl. G06F 15/16

(52) U.S. Cl. 709/206; 709/203

(57) ABSTRACT

An SMTP server 100 for relaying an e-mail which is transmitted between cellular phones and performing a lottery to award a prize to users of the cellular phones, has a receiving portion 101 for receiving the e-mail from a sender-side cellular phone 200, a sending portion 103 for sending the e-mail to a receiver-side cellular phone 300, a send information storing portion 104 for storing send information of the e-mail that is received by receiving portion 101 every cellular phone as the destination of the e-mail, and a lot-drawing portion 105 for deciding a winning probability of a drawing of lots applied to a user of the receiver-side cellular phone 300 according to the send information stored in the send information storing portion 104 and then executing a lot-drawing to the user of the receiver-side cellular phone 300.

### BACKGROUND OF THE INVENTION

1. Field of the Invention

The present invention relates to an e-mail processing server which relays an e-mail which is transmitted between mobile terminals and performs a lottery to award a prize to users of the mobile terminals.

2. Description of the Related Art

In the related art, a service of performing the lottery to award the prize to user of a terminal is provided. This service is carried out in such a manner that the user accesses a prize server by utilizing the terminal to enter predetermined prize and then the prize is awarded to users when the users win the prize. Also, in this service, the process of increasing a winning probability of the drawing of lots according to the number of accesses issued from the terminal to the server can be carried out. Thus, if the user has the larger number of accesses, such user can have a higher probability of carrying off the prize. Therefore, the server manager side has the advantage such that an increase in the number of accesses to the server can be expected (For example, see JP-A-2002-117323).

As mentioned above, JP-A-2002-117323 is known as a related art.

The case where the above service in the related art is applied to the server that relays an e-mail which is transmitted is considered. In this case, if such a service is provided that the sender of the e-mail can enter the prize by sending the e-mail to the destination and the winning probability of the drawing of lots can be increased according to the number of transmission of the e-mail, the promotion of use of the e-mail can be expected.

However, if the terminal that sends/receives the above e-mail is the cellular phone, the communication expense is required of both the sender side and the receiver side to send/receive the e-mail. Therefore, the sender of the e-mail can increase his or her own winning probability by sending a large number of e-mails to the cellular phone as the destination, so that a possibility that the sender can win the prize is increased. However, such a problem is caused that the receiver of the e-mail cannot carry off the prize, nevertheless such receiver must bear the communication expense generated at the time when he or she received the e-mail.

### SUMMARY OF THE INVENTION

An object of the present invention is to provide an e-mail processing server which is capable of providing a prize awarding service that is also profitable for a receiver of an e-mail.

The invention provides an e-mail processing server for relaying an e-mail which is transmitted between mobile terminals and performing a lottery to award a prize to user of the mobile terminal, having: sending/receiving means for receiving an e-mail from a first mobile terminal and sending the e-mail to a second mobile terminal; storing means for storing send information of the e-mail, which is sent from the sending/receiving means, every mobile terminal as destination of the e-mail; winning probability deciding means for deciding a winning probability of a drawing of lots applied to a user of the second mobile terminal according to the send information stored in the storing means; and lot-drawing means for executing a lot-drawing at the winning probability decided by the winning probability deciding means.

According to this configuration, the winning probability of the drawing of lots applied to the user of the mobile terminal as the destination of the e-mail is decided according to the send information of the stored e-mail. Therefore, the service that is profitable for the receiver of the e-mail can be provided by increasing the winning probability of the user who has a large mount of received e-mail, for example.

Furthermore, the sending/receiving means involves:
receiving means for receiving the e-mail from the first mobile terminal; notice information sending means for sending notice information, which informs an event that the e-mail is sent, to the second mobile terminal; request-to-send information receiving means for receiving request-to-send information, which is sent from the second mobile terminal, for requesting to send an e-mail that the notice information shows; and sending means for sending an e-mail to the second mobile terminal in response to the request-to-send information received by the request-to-send information receiving means.

According to this configuration, the winning probability of the drawing of lots applied to the user of the mobile terminal as the destination of the e-mail is decided according to the send information of the stored e-mail. Therefore, the service that is profitable for the receiver of the e-mail can be provided by increasing the winning probability of the user who has a large mount of reception of the e-mail, for example.

The invention also provides an e-mail processing server for relaying an e-mail which is transmitted between mobile terminals and performing a lottery to award a prize to users of the mobile terminals, having: sending/receiving means for receiving an e-mail from a first mobile terminal and sending the e-mail to a second mobile terminal; storing means for storing send information of the e-mail, which is sent by the sending/receiving means, every mobile terminal as destination of the e-mail; and lot-drawing means for executing a lot-drawing applied to a user of the second mobile terminal when the send information stored in the storing means satisfy predetermined condition.

According to this configuration, the lottery to award the prize to the user of the mobile terminal as the destination of the e-mail is performed according to the send information of the stored e-mail. Therefore, the service that is profitable for the receiver of the e-mail can be provided by performing the lottery only to the user who has a large mount of reception of the e-mail.

Furthermore, the sending/receiving means involves: receiving means for receiving the e-mail from the first mobile terminal; notice information sending means for sending notice information, which informs an event that the e-mail is sent, to the second mobile terminal; request-to-send information receiving means for receiving request-to-send information, which is sent from the second mobile terminal, for requesting to send an e-mail that that the notice information shows; and sending means for sending an e-mail to the second mobile terminal in response to the request-to-send information received by the request-to-send information receiving means.

According to this configuration, the lottery to award the prize to the user of the mobile terminal as the destination of the e-mail is held according to the send information of the stored e-mail. Therefore, the service that is profitable for the receiver of the e-mail can be provided by running the lottery only to the user who has a large mount of reception of the e-mail.

The e-mail processing server further having: acquiring means for acquiring storing location information showing storing location on a network, where contents of a prize awarded to a user who won the lot-drawing are stored, from a database; and storing location information sending means for attaching the storing location information acquired by the acquiring means to an e-mail, which is to be sent to a mobile terminal of the user who won the lot-drawing, and then sending the e-mail to the mobile terminal.

According to this configuration, the user who is chosen by the lottery can check the contents of the prize based on the storing location information attached to the e-mail. Also, since the storing location information indicating that the user won the prize is attached to the e-mail, the user can recognize in real time that the user is chosen by the lottery.

The e-mail processing server, in which the prize involves digital contents that are enabled to play with the mobile terminal, and further having: acquiring means for acquiring storing location information showing storing location on a network, where the digital contents are stored, from a database; and storing location information sending means for attaching the storing location information acquired by the acquiring means to an e-mail, which is to be sent to a mobile terminal of the user who won the lot-drawing, and then sending the e-mail to the mobile terminal.

According to this configuration, if the user of the mobile terminal accesses the storing location based on the storing location information sent from the e-mail processing server, such user can get the digital contents as the prize immediately after the winning. Also, since the storing location information indicating that the user won the prize is attached to the e-mail, the user can recognize in real time that the user is chosen by the lottery.

### BRIEF DESCRIPTION OF THE DRAWINGS

FIG. 1 is a configurative view of an e-mail processing system according to a first embodiment of the present invention;

FIG. 2 is a flowchart explaining a flow until an e-mail is sent to a receiver-side cellular phone after such e-mail is received by an SMTP server;

FIG. 3 is a configurative view of an e-mail processing system according to a second embodiment of the present invention; and

FIG. 4 is a flowchart explaining a flow until the e-mail is sent to the receiver-side cellular phone after such e-mail is received by the SMTP server.

### DETAILED DESCRIPTION OF THE PREFERRED EMBODIMENTS

Embodiments of the present invention will be explained with reference to the drawings hereinafter.

### First Embodiment

In an e-mail processing system to be explained in the following, such a rate system is employed that the expense is generated on both the sender side and the receiver side of the e-mail according to an amount of data of the e-mail.

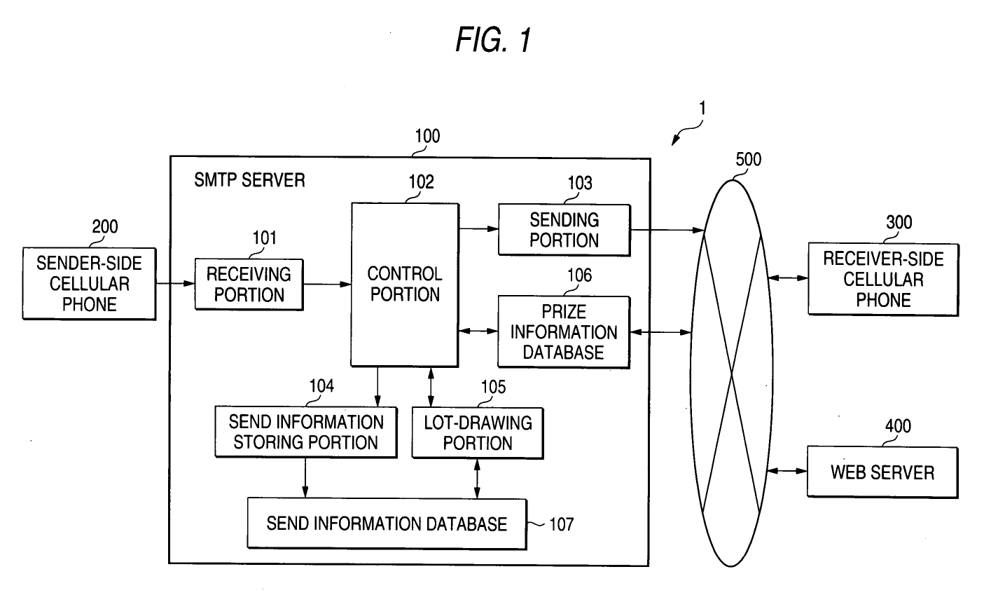

FIG. 1 is a configurative view of an e-mail processing system according to a first embodiment of the present invention. An e-mail processing system 1 is constructed to include a sender-side cellular phone 200 as the terminal for sending an e-mail like PC, mobile information terminal, and cellular phone, etc., an SMTP server 100 for sending out an e-mail sent from the sender-side cellular phone 200 to a network 500 based on SMTP (Simple Mail Transfer Protocol), a network 500 such as the Internet, etc., a receiver-side cellular phone 300 for receiving the e-mail sent from the sender-side cellular phone 200, and a web server 400 for providing the information in answer to HTTP (Hypertext Transfer Protocol) request issued from the receiver-side cellular phone 300.

The SMTP server 100 and the web server 400 are connected to the network 500 by the cable or via the radio. The receiver-side cellular phone 300 can be connected to the network 500 via the radio.

The sender-side cellular phone 200 is a terminal that sends out an e-mail to the receiver-side cellular phone 300. The receiver-side cellular phone 300 contains the browser that can access URL referred to in the received e-mail, and can access the web server 400 based on HTTP.

The SMTP server 100 includes a receiving portion 101, a control portion 102, a sending portion 103, a send information storing portion 104, a lot-drawing portion 105, a prize information database 106, and a send information database 107. The prize information database 106 and the send information database 107 may be accessed by the SMTP server 100, and a database that is provided on the outside of the SMTP server 100 may be employed.

The receiving portion 101 receives an e-mail sent from the sender-side cellular phone 200, and transfers the received e-mail to the control portion 102. The sending portion 103 sends out the e-mail transferred from the control portion 102 to the receiver-side cellular phone 300 via the network 500 based on SMTP under control of the control portion 102.

The send information storing portion 104 extracts send information (a type of the cellular phone as the destination, an amount of sent data, etc.) of the e-mail, which is received from the receiving portion 101, from header information, etc. of the e-mail, and then stores them in the send information database 107.

The send information of the e-mail received by the receiving portion 101 are stored in the send information database 107 every cellular phone as the destination of the e-mail. For example, if in the past the e-mail was sent out ten times to a certain cellular phone “A” and an amount of data of the e-mail sent out ten times is 1 mega byte in total, numerical values such that the number of reception of the e-mail is ten times and an amount of received data is 1 mega byte in total are recorded in the send information database 107 with respect to the cellular phone “A”.

The lot-drawing portion 105 decides a winning probability of the drawing of lots, which is applied to the owner of the cellular phone as the destination of the e-mail (referred to as the “destination user” hereinafter), based on the send information that are stored in the cellular phone as the destination of the e-mail received by the receiving portion 101, then executes the drawing of lots based on the decided winning probability, and then informs the control portion 102 of the result of the drawing of lots. For example, a high winning probability is applied to the destination user who has the larger number of reception of the e-mail than a predetermined value, or the destination user who has a larger amount of received data of the e-mail than another predetermined value. Also, a uniform winning probability is set to all the destination users who have the number of reception of the e-mail and an amount of received data that are smaller than the predetermined value respectively.

The information that indicate contents of the prize, which is given to the destination user of the e-mail received by the receiving portion 101 (sentences explaining the present of the tour ticket, etc.), are recorded in the prize information database 106 by allocating them to the proper URL (Universal Resource Locator).

The prize information database 106 is a common database that the web server 400 can directly access to download desired prize information. Also, if the prize awarded to the destination user are prepared as digital contents such as a wallpaper or an incoming call melody of the cellular phone, a game for the cellular phone, etc., not the information indicating the contents of the prize but the digital contents themselves are recorded in the prize information database 106.

The control portion 102 not only controls respective portions but also applies processes to the e-mail, which is transferred from the receiving portion 101, in response to the result of the drawing of lots informed by the lot-drawing portion 105. When the information indicating that the destination user of the e-mail transferred from the receiving portion 101 won the prize is sent from the lot-drawing portion 105, URL information of the prize that is given to the user is attached to the e-mail and then the e-mail is transferred to the sending portion 103. In contrast, when the destination user did not win the prize, no process is applied to the e-mail and then the e-mail is transferred to the sending portion 103 as it is.

The web server 400 downloads the prize information from the prize information database 106 based on the URL information contained in the HTTP request from the receiver-side cellular phone 300, and then returns the downloaded prize information to the receiver-side cellular phone 300 at the HTTP response.

Next, operations of the e-mail processing system 1 executed until the prize information is acquired by the receiver-side cellular phone 300 after the e-mail is received by the SMTP server 100 will be explained hereunder.

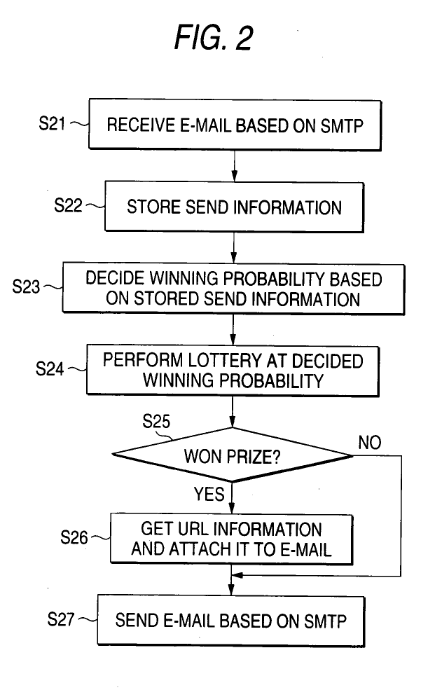

FIG. 2 is a flowchart explaining a flow required until the e-mail is sent to the receiver-side cellular phone after such e-mail is received by the SMTP server.

When the e-mail is received by the SMTP server 100 based on SMTP (S21), the send information of the e-mail are stored in the send information database 107 (S22), and then the winning probability of the drawing of lots, which is applied to the destination user of the e-mail, is decided based on the stored send information (S23). When the winning probability is decided, a lottery is executed based on the winning probability (S24).

If the destination user won the prize according to this drawing of lots (S25: YES), the URL information of the prize information about the prize that is given to the destination user is attached to the e-mail (S26), and then the e-mail is sent to the receiver-side cellular phone 300 based on SMTP (S27). In contrast, if the destination user did not win the prize (S25: NO), the e-mail is sent to the receiver-side cellular phone 300 as it is (S27).

The receiver-side cellular phone 300 that received the e-mail, to which the URL information is attached, accesses the URL information based on HTTP. In the case the access to the URL information is executed by the receiver-side cellular phone 300, the web server 400 receives the HTTP request. Then, the prize information is acquired based on the URL information contained in the request, and then the acquired prize information is returned to the receiver-side cellular phone 300 at the HTTPP response.

The prize information is displayed on the browser of the receiver-side cellular phone 300. The user of the receiver-side cellular phone 300 carries the receiver-side cellular phone 300 to the service shop side, which accepts the exchange of the prize, based on this prize information, and then receives the prize by showing the prize information on the browser to the service shop side.

In the above explanation, only the destination user performs a lottery. However, the type of the cellular phone of the sender of the e-mail, a total amount of sent data, the total number of transmission, etc. may be stored as the send information of the e-mail, and then the sender of the e-mail may perform a lottery at the winning probability that is decided based on these information.

As described above, according to the present embodiment, the winning probability of the drawing of lots is decided based on the send information stored every destination user of the e-mail. Thus, the destination user can increase a probability of carrying off the prize as the user receives the e-mail more and more. Therefore, the service that is profitable for the destination user who bears the receiving rate of the e-mail can be provided.

Also, the e-mail to which the URL information as the information indicating the contents of the prize is attached is sent to the won destination user. Thus, the won user can immediately know the contents of the prize based on the URL information.

Also, in the e-mail processing system of the present embodiment, the user can merely enter the prize by carrying out the operation that is conducted usually everyday, i.e., the work to send/receive the e-mail. Thus, the user does not become aware of the entry for the prize, but such user can capture the prize. In contrast, the system manager can expect increases in the number of the sending/receiving of the e-mail and an amount of received data. Therefore, the service that is profitable for both the user of the cellular phone and the system manager can be provided.

In the present embodiment, the lot-drawing portion 105 decides the winning probability of the drawing of lots based on the send information stored in the send information database 107, and then performs the lottery. The lot-drawing portion 105 may start the drawing of lots when the send information stored in the send information database 107 satisfy predetermined condition.

For example, such a process may be carried out that the lottery may be held once every time when the number of the received e-mail of the destination user exceeds 100 or the lottery may be held once every time when a total amount of received data of the e-mail of the destination user comes up to 1 mega byte. The same advantages as above can be achieved by doing the process in this manner.

### Second Embodiment

An e-mail processing system according to a second embodiment of the present invention is constructed such that the receiver side of the e-mail can decide whether or not the receiver receives the e-mail. In other words, if the e-mail is unnecessary, it is decided that the receiver does not receive such e-mail, so that the system can eliminate the waste of the rate required to receive the e-mail.

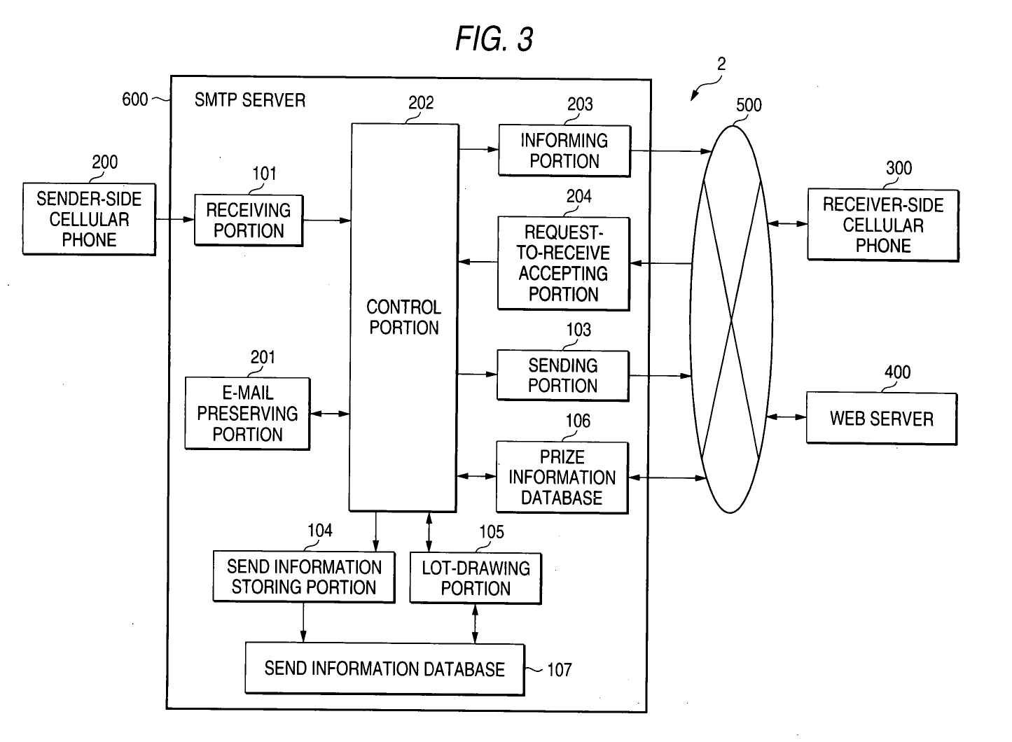

FIG. 3 is a configurative view of the e-mail processing system according to the second embodiment of the present invention. In an SMTP server 600 of an e-mail processing system 2, an e-mail preserving portion 201, an e-mail reception informing portion 203, and an e-mail request-to-receive accepting portion 204 are added to the configuration of the SMTP server 100 in the e-mail processing system 1 explained in the first embodiment.

The e-mail preserving portion 201 preserves the e-mail, which is received by the receiving portion 101, for a predetermined term. The e-mail reception informing portion 203 informs the receiver-side cellular phone 300 of the fact that the e-mail is received by the receiving portion 101 and the e-mail is kept in the e-mail preserving portion 201 by sending an e-mail reception informing mail. Sender information, case name, and a part of the body of the e-mail, etc. are contained in the e-mail reception informing mail. The user of the receiver-side cellular phone 300 checks the e-mail reception informing mail to decide whether or not he or she receives the full text of the e-mail.

When the user of the receiver-side cellular phone 300 wishes to receive the full text of the e-mail by checking the e-mail reception informing mail, the e-mail request-to-receive accepting portion 204 accepts the e-mail request-to-receive sent by the user and informs a control portion 202.

The control portion 202 gets the e-mail, which is requested by the destination user, from the e-mail preserving portion 201 based on the notice issued from the e-mail reception informing portion 203. The storing portion 104 stores send information of the e-mail that control portion 202 got in the send information database 107.

Next, operations of the e-mail processing system 2 required until prize information is gotten by the receiver-side cellular phone 300 after the e-mail is received by the SMTP server 600 will be explained hereunder.

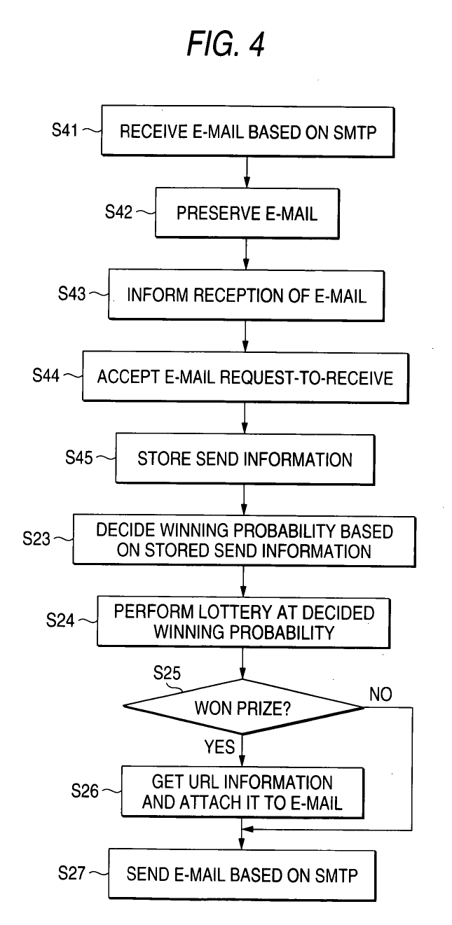

FIG. 4 is a flowchart explaining a flow until the e-mail is sent to the receiver-side cellular phone after such e-mail is received by the SMTP server. The same symbols are affixed to the same operations as those in FIG. 2, and their explanation will be omitted.

When the e-mail is received by the SMTP server 600 based on SMTP (S41), such e-mail is temporarily kept (S42), and then the e-mail reception informing mail is sent to the receiver-side cellular phone 300 (S43). When the request to receive the full text of the e-mail is issued from the receiver-side cellular phone 300 that received the e-mail reception informing mail, the e-mail request-to-receive is accepted (S44), and then the send information of the reserved e-mail is stored (S45). Subsequent operations are similar to those in the first embodiment.

As described above, according to the present embodiment, the winning probability of the drawing of lots is decided based on the send information that are stored every destination user of the e-mail. Therefore, the same advantages can be attained.

Also, the probability of carrying off the prize can be increased by increasing the number of reception of the e-mail and an amount of received data. Thus, even though the e-mail is the information that is unnecessary for the user (commercial mail, or the like), the user of the receiver-side cellular phone 300 tends to receive the full text of the e-mail. Therefore, the streaming dealers of the commercial mail, etc. can improve the commercial effect. In addition, the communication dealers who manage transmission/reception of the e-mail between the cellular phones can promote the use of the e-mail.

1. An e-mail processing server for relaying an e-mail which is transmitted between mobile terminals and performing a lottery to award a prize to user of the mobile terminal, comprising:
sending/receiving means for receiving an e-mail from a first mobile terminal and sending the e-mail to a second mobile terminal;
storing means for storing send information of the e-mail, which is sent from the sending/receiving means, every mobile terminal as destination of the e-mail;
winning probability deciding means for deciding a winning probability of a drawing of lots applied to a user of the second mobile terminal according to the send information stored in the storing means; and
lot-drawing means for executing a lot-drawing at the winning probability decided by the winning probability deciding means.

2. The e-mail processing server according to claim 1, wherein
the sending/receiving means involves:
receiving means for receiving the e-mail from the first mobile terminal;
notice information sending means for sending notice information, which informs an event that the e-mail is sent, to the second mobile terminal;
request-to-send information receiving means for receiving request-to-send information, which is sent from the second mobile terminal, for requesting to send an e-mail that the notice information shows; and
sending means for sending an e-mail to the second mobile terminal in response to the request-to-send information received by the request-to-send information receiving means.

3. An e-mail processing server for relaying an e-mail which is transmitted between mobile terminals and performing a lottery to award a prize to users of the mobile terminals, comprising:
sending/receiving means for receiving an e-mail from a first mobile terminal and sending the e-mail to a second mobile terminal;
storing means for storing send information of the e-mail, which is sent by the sending/receiving means, every mobile terminal as destination of the e-mail; and
lot-drawing means for executing a lot-drawing applied to a user of the second mobile terminal when the send information stored in the storing means satisfy predetermined condition.

4. The e-mail processing server according to claim 3, wherein
the sending/receiving means involves:
receiving means for receiving the e-mail from the first mobile terminal;
notice information sending means for sending notice information, which informs an event that the e-mail is sent, to the second mobile terminal;
request-to-send information receiving means for receiving request-to-send information, which is sent from the second mobile terminal, for requesting to send an e-mail that that the notice information shows; and
sending means for sending an e-mail to the second mobile terminal in response to the request-to-send information received by the request-to-send information receiving means.

5. The e-mail processing server according to claim 1, further comprising:
acquiring means for acquiring storing location information showing storing location on a network, where contents of a prize awarded to a user who won the lot-drawing are stored, from a database; and
storing location information sending means for attaching the storing location information acquired by the acquiring means to an e-mail, which is to be sent to a mobile terminal of the user who won the lot-drawing, and then sending the e-mail to the mobile terminal.

6. The e-mail processing server according to claim 3, further comprising:
acquiring means for acquiring storing location information showing storing location on a network, where contents of a prize awarded to a user who won the lot-drawing are stored, from a database; and
storing location information sending means for attaching the storing location information acquired by the acquiring means to an e-mail, which is to be sent to a mobile terminal of the user who won the lot-drawing, and then sending the e-mail to the mobile terminal.

7. The e-mail processing server according to claim 1, wherein the prize involves digital contents that are enabled to play with the mobile terminal, and further comprising:
acquiring means for acquiring storing location information showing storing location on a network, where the digital contents are stored, from a database; and
storing location information sending means for attaching the storing location information acquired by the acquiring means to an e-mail, which is to be sent to a mobile terminal of the user who won the lot-drawing, and then sending the e-mail to the mobile terminal.

8. The e-mail processing server according to claim 3, wherein the prize involves digital contents that are enabled to play with the mobile terminal, and further comprising:
acquiring means for acquiring storing location information showing storing location on a network, where the digital contents are stored, from a database; and
storing location information sending means for attaching the storing location information acquired by the acquiring means to an e-mail, which is to be sent to a mobile terminal of the user who won the lot-drawing, and then sending the e-mail to the mobile terminal.
